(19) United States
(12) Patent Application Publication
(10) Pub. No.: US 2026/0296543 A1
(43) Pub. Date: Oct. 1, 2026

(54) DISPLAY DEVICE, DISPLAY METHOD, AND STORAGE MEDIUM

(71) Applicant: HONDA MOTOR CO., LTD., Tokyo (JP)

(72) Inventors: Kazuki Kamata, Tokyo (JP); Tomotaka Teramachi, Tokyo (JP); Yugo Kajiwara, Tokyo (JP); Yuta Inaba, Tokyo (JP)

(21) Appl. No.: 19/544,072

(22) Filed: Feb. 19, 2026

(30) Foreign Application Priority Data
Mar. 28, 2025 (JP) 2025-055465

(51) Int. Cl. B62D 15/02

(52) U.S. Cl. CPC B62D 15/029; B62D 15/0255

(57) ABSTRACT

A display device includes an output interface including at least a display, and an output control unit configured to, using the output interface, guide a vehicle to a recommended lane to which the vehicle is be moved with a lane change, and recommend, to the occupant of the vehicle, execution of auto lane changing to the recommended lane, wherein the output control unit causes lane guidance information that is information indicating guidance for the recommended lane and auto lane changing recommendation information that is information indicating recommendation of execution of the auto lane changing to the occupant, to be displayed on the same screen of the display, and causes the lane guidance information to be displayed on the screen simultaneously with the recommendation of the auto lane changing being disapproved.

### CROSS-REFERENCE TO RELATED APPLICATION

This application is based upon and claims the benefit of priority from Japanese Patent Application No. 2025-055465, filed Mar. 28, 2025, the entire content of which is incorporated herein by reference.

### BACKGROUND

### Field of the Invention

The present invention relates to a display device, a display method, and a storage medium.

### Description of Related Art

In recent years, initiatives to provide access to sustainable transportation systems that also give consideration to people who are in a vulnerable position among traffic participants have been intensifying. To realize this, efforts are being focused on research and development to further improve the safety or convenience of traffic through research and development regarding automated driving technology. Incidentally, as one driving assistance technology, a technology in which, when auto lane changing cannot be executed while a vehicle is traveling along a current route, an occupant is notified that the auto lane change is canceled, guidance for an alternative route along which the auto lane change can be continued is provided to the occupant, or guidance for manual driving is provided to the occupant is known (see, for example, Japanese Unexamined Patent Application, First Publication No. 2023-119561).

### SUMMARY

In the related art, various pieces of information are provided to an occupant when auto lane changing cannot be executed, but there remains room for further improvement in the manner of providing information related to such driving assistance, and there is room to further enhance the convenience for the occupant.

An object of the present invention is to further improve convenience of an occupant by providing information related to driving assistance to the occupant in an easier-to-understand manner. As a result, the present invention contributes to the development of sustainable transportation systems.

A display device, a display method, and a storage medium according to the present invention adopt the following configurations.
(1) A first aspect of the present invention is a display device including: an output interface including at least a display; and an output control unit configured to, using the output interface, guide a vehicle to a recommended lane to which the vehicle is be moved with a lane change, and recommend, to the occupant of the vehicle, execution of auto lane changing to the recommended lane, wherein the output control unit causes lane guidance information that is information indicating guidance for the recommended lane and auto lane changing recommendation information that is information indicating recommendation of execution of the auto lane changing to the occupant, to be displayed on the same screen of the display, and causes the lane guidance information to be displayed on the screen simultaneously with the recommendation of the auto lane changing being disapproved.
(2) A second aspect of the present invention is the display device according to the first aspect, wherein the lane guidance information includes first lane guidance information, and second lane guidance information for more strongly requesting movement to the recommended lane than the first lane guidance information, and the output control unit causes the first lane guidance information to be displayed on the screen before the recommendation of the auto lane changing is disapproved, and causes the second lane guidance information to be displayed on the screen when the recommendation of the auto lane changing is disapproved or after the recommendation of the auto lane changing is disapproved.
(3) A third aspect of the present invention is the display device according to the second aspect, wherein the output control unit causes the first lane guidance information to be displayed on the screen simultaneously with the recommendation of the auto lane changing being started.
(4) A fourth aspect of the present invention is the display device according to the second aspect, further including: an input interface operated by the occupant, wherein the output control unit does not cause the second lane guidance information to be displayed on the screen even when the vehicle approaches a guidance point that is a point at which guidance to the recommended lane is performed, when the auto lane changing is started in response to an approval operation being input to the input interface, the approval operation being an operation by the occupant for approving the recommendation of the auto lane changing.
(5) A fifth aspect of the present invention is the display device according to the fourth aspect, wherein the output control unit continues to cause the first lane guidance information to be displayed on the screen during a period in which the auto lane changing is being executed.
(6) A sixth aspect of the present invention is the display device according to the second aspect, further including: a steering apparatus for adjusting a traveling path of the vehicle, wherein the output control unit does not cause the second lane guidance information to be displayed on the screen even when the vehicle approaches a guidance point that is a point at which guidance to the recommended lane is performed, when the occupant has started manual lane changing using the steering apparatus during a period in which the auto lane changing is recommended.
(7) A seventh aspect of the present invention is the display device according to the sixth aspect, wherein the output control unit continues to display the first lane guidance information on the screen during a period in which manual lane changing is being executed.
(8) An eighth aspect of the present invention is the display device according to the second aspect, further including: a steering apparatus for adjusting a traveling path of the vehicle, wherein the output control unit stops displaying the lane guidance information when the occupant has started manual lane changing using the steering apparatus to move the vehicle to the recommended lane during a period in which the first lane guidance information is displayed on the screen or when the auto lane changing has been started to move the vehicle to the recommended lane.
(9) A ninth aspect of the present invention is a display method using a computer mounted on a vehicle including an output interface including at least a display, the display method including: using the output interface to guide a vehicle to a recommended lane to which the vehicle is to be moved with a lane change and to recommend execution of auto lane changing to the recommended lane to an occupant of the vehicle; causing lane guidance information that is information indicating guidance for the recommended lane and auto lane changing recommendation information that is information indicating recommendation of execution of the auto lane changing to the occupant, to be displayed on the same screen of the display; and causing the lane guidance information to be displayed on the screen simultaneously with the recommendation of the auto lane changing being disapproved.
(10) A tenth aspect of the present invention is a non-transitory computer-readable storage medium storing a program to be executed by a computer mounted on a vehicle including an output interface including at least a display, the program including: using the output interface to guide a vehicle to a recommended lane to which the vehicle is to be moved with a lane change and to recommend execution of auto lane changing to the recommended lane to an occupant of the vehicle; causing lane guidance information that is information indicating guidance for the recommended lane and auto lane changing recommendation information that is information indicating recommendation of execution of the auto lane changing to the occupant, to be displayed on the same screen of the display; and causing lane guidance information to be displayed on the screen simultaneously with the recommendation of the auto lane changing being disapproved.

According to the above aspects, it is possible to further improve convenience of the occupant by providing information related to driving assistance to the occupant in an easier-to-understand manner.

### BRIEF DESCRIPTION OF THE DRAWINGS

FIG. 1 is a configuration diagram of a vehicle system using a display device of an embodiment.

FIG. 2 is a diagram schematically illustrating an interior state of a host vehicle.

FIG. 3 is a diagram illustrating an example of a command switch 34.

FIG. 4 is a functional block diagram of a first control unit, a second control unit, and a third control unit according to an embodiment.

FIG. 5 is a diagram illustrating an example of a situation in which a host vehicle is traveling.

FIG. 6 is a diagram illustrating an example of a screen of a first display during free driving.

FIG. 7 is a diagram illustrating an example of a screen of the first display under a weak lane guidance recommendation.

FIG. 8 is a diagram illustrating an example of the screen of the first display under a strong lane guidance recommendation.

FIG. 9 is a flowchart illustrating an example of a series of processes in an automated driving control device according to the embodiment.

FIG. 10 is a diagram illustrating an example of a situation in which an ALC recommendation is not approved.

FIG. 11 is a diagram illustrating an example of a screen of the first display in scene S1-1.

FIG. 12 is a diagram illustrating an example of a screen of the first display in scene S1-2.

FIG. 13 is a diagram illustrating an example of a screen of the first display in scene S1-3.

FIG. 14 is a diagram illustrating an example of a screen of the first display in scene S1-4.

FIG. 15 is a diagram illustrating an example of a screen of the first display in scene S1-5.

FIG. 16 is a diagram illustrating an example of a situation in which the ALC recommendation is approved.

FIG. 17 is a diagram illustrating an example of a screen of the first display in scene S2-4.

### DESCRIPTION OF EMBODIMENTS

Hereinafter, embodiments of the display device, the display method, and the storage medium of the present invention will be described with reference to the drawings.

The display device of the embodiment is applicable, for example, to an automated driving vehicle. Automated driving refers, for example, to controlling the driving of a vehicle by controlling one or both of speed and steering of the vehicle. Driving control of the vehicle described above includes various types of driving control such as adaptive cruise control system (ACC), traffic jam pilot (TJP), auto lane changing (ALC), collision mitigation brake system (CMBS), and lane keeping assistance system (LKAS). Driving of the automated driving vehicle may also be controlled by manual driving of an occupant (driver). Hereinafter, a case in which a left-hand traffic regulation applies will be described, but when a right-hand traffic regulation applies, left and right may be read in reverse.

### Overall Configuration

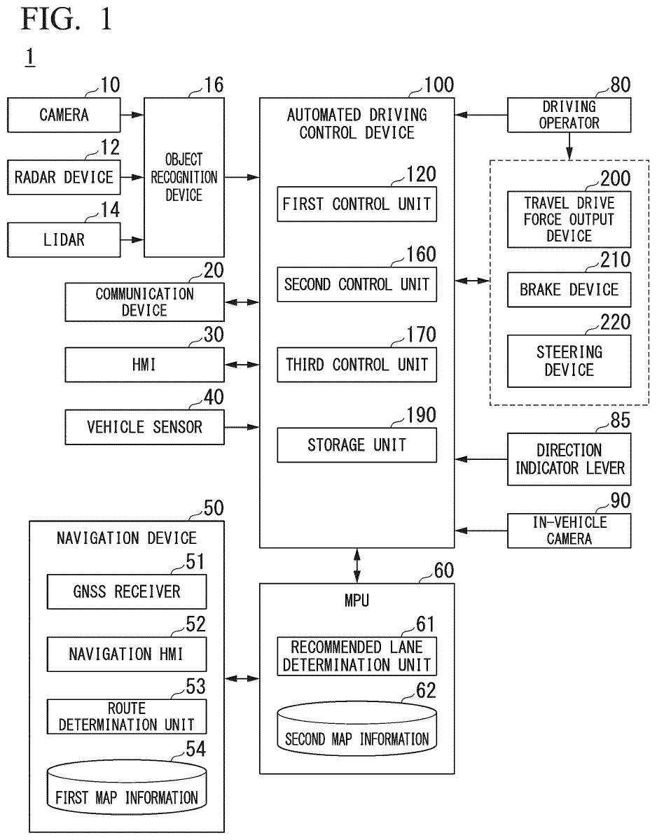

FIG. 1 is a configuration diagram of a vehicle system 1 using a display device according to an embodiment. A vehicle on which the vehicle system 1 is mounted (hereinafter referred to as a “host vehicle M”) is, for example, a two-wheeled, three-wheeled, or four-wheeled vehicle, and a drive source thereof includes an internal combustion engine such as a diesel engine or a gasoline engine, an electric motor, or a combination thereof. The electric motor operates using electric power generated by a generator coupled to the internal combustion engine, or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, vehicle sensors 40, a navigation device 50, a map positioning unit (MPU) 60, a driving operator 80, a direction indicator lever 85, an in-vehicle camera 90, an automated driving control device 100, a travel drive force output device 200, a brake device 210, and a steering device 220. These devices or units are interconnected by a multiplex communication line such as a controller area network (CAN) communication line, a serial communication line, or a wireless communication network, or the like. The configuration illustrated in FIG. 1 is merely an example, part of the configuration may be omitted, or additional configurations may be added. In particular, a combination of the HMI 30, the navigation device 50, the MPU 60, the driving operator 80, the direction indicator lever 85, and the automated driving control device 100 is an example of a “display device.”

The camera 10 is, for example, a digital camera that uses a solid-state imaging element such as a charge coupled device (CCD) or a complementary metal oxide semiconductor (CMOS). The camera 10 is attached at any location on the host vehicle M. When the camera 10 images the front of the host vehicle M, the camera 10 may be attached on an upper part of a front windshield, on a back surface of the room mirror, or the like. When the camera 10 images the rear of the host vehicle M, the camera 10 may be attached on an upper part of the rear windshield, or the like. When the camera 10 images a right or left side of the host vehicle M, the camera 10 may be attached to, for example, a right or left side surface of a vehicle body or door mirror. The camera 10 periodically and repeatedly images the surroundings of the host vehicle M. The camera 10 may be a stereo camera.

The radar device 12 radiates radio waves such as millimeter waves to the surroundings of the host vehicle M and detects radio waves (reflected waves) reflected by an object, thereby detecting at least a position (distance and direction) of the object. The radar device 12 may be attached at any location on the host vehicle M. The radar device 12 may detect the position and speed of the object using a frequency modulated continuous wave (FM-CW) scheme.

The LIDAR 14 irradiates light to the surroundings of the host vehicle M and measures scattered light of the irradiated light. The LIDAR 14 detects a distance to a target based on time from emission to reception. The irradiated light may be, for example, pulsed laser light. The LIDAR 14 may be attached at any location on the host vehicle M.

The object recognition device 16 performs sensor-fusion processing on detection results obtained by some or all of the camera 10, the radar device 12, and the LIDAR 14, and recognizes, for example, the position, type, and speed of the object. The object recognition device 16 outputs the recognition results to the automated driving control device 100. The object recognition device 16 may output detection results of the camera 10, the radar device 12, and the LIDAR 14 directly to the automated driving control device 100. The object recognition device 16 may be omitted from the vehicle system 1.

The communication device 20 uses, for example, a cellular network, a Wi-Fi network, Bluetooth (registered trademark; hereinafter omitted), dedicated short range communication (DSRC), or the like to communicate with other vehicles present around the host vehicle M or communicate with various server devices via a wireless base station.

The HMI 30 presents various kinds of information to occupants of the host vehicle M and accepts input operations from the occupants. For example, the HMI 30 includes a display device 32 and a command switch 34. The display device 32 includes, for example, a first display 32A and a second display 32B.

The HMI 30 may further include a speaker, a buzzer, a touch panel, a microphone, and the like. The display device 32, the speaker, the buzzer, and the like included in the HMI 30 are examples of an “output interface,” and the command switch 34, the touch panel, the microphone, and the like included in the HMI 30 are examples of an “input interface.”

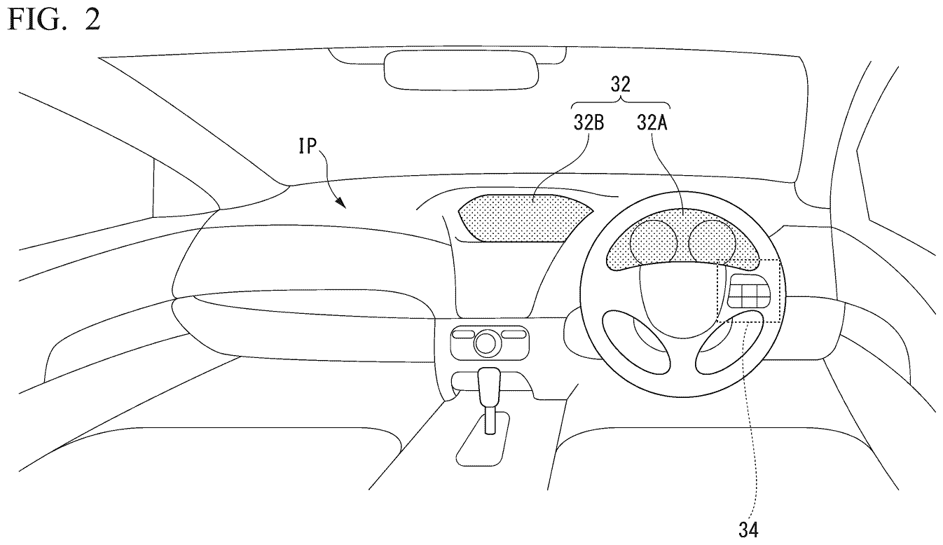

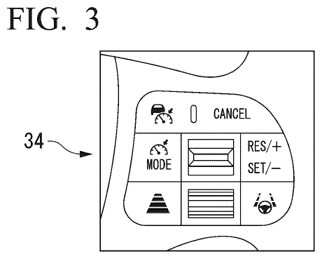

FIG. 2 is a diagram schematically illustrating a state inside the host vehicle M. FIG. 3 is a diagram illustrating an example of the command switch 34. For example, the first display 32A is provided near the front of a driver's seat (a seat closest to a steering wheel) on an instrument panel IP, and is installed at a position that the occupant can visually recognize through a gap in the steering wheel or over the steering wheel.

The first display 32A is, for example, a liquid crystal display (LCD) or an organic electro luminescence (EL) display device. The first display 32A displays, as an image, information necessary for travel during manual driving or driving assistance of the host vehicle M. The first display 32A is an example of a “display.”

The information necessary for the travel of the host vehicle M during manual driving includes, for example, speed, engine speed, remaining fuel, radiator water temperature, travel distance, remaining battery level, and other information of the host vehicle M.

The information necessary for the travel of the host vehicle M during driving assistance is, for example, information of a future trajectory of the host vehicle M (a target trajectory to be described later), whether a lane change will occur, a lane that is a lane change destination, recognized lanes (lane markings), other vehicles, and the like.

Further, the information necessary for the travel of the host vehicle M during driving assistance may include some or all of the information necessary for the travel of the host vehicle M during manual driving.

The second display 32B is installed, for example, near a center of the instrument panel IP. The second display 32B is, for example, an LCD or organic EL display device, like the first display 32A. The second display 32B displays, for example, a navigation results of the navigation device 50 as an image. The second display 32B may display television programs, play DVDs, or display content such as downloaded movies.

The command switch 34 is typically attached to the steering wheel. The command switch 34 may be a single switch or may be an assembly in which a plurality of switches are integrated. The command switch 34 may be attached to a steering column cover or the vicinity thereof instead of or in addition to the steering wheel, may be attached on the instrument panel IP, or may be attached to a center console.

The vehicle sensor 40 includes a vehicle-speed sensor that detects speed of the host vehicle M, an acceleration sensor that detects acceleration, a yaw-rate sensor that detects an angular velocity around a vertical axis, and a direction sensor that detects an orientation of the host vehicle M.

The navigation device 50 includes, for example, a global navigation satellite system (GNSS) receiver 51, a navigation human machine interface (HMI) 52, and a route determination unit 53. The navigation device 50 stores first map information 54 in a storage device such as a hard disk drive (HDD) or a flash memory.

The GNSS receiver 51 determines the position of the host vehicle M based on signals received from GNSS satellites. The position of the host vehicle M may also be determined or supplemented by an inertial navigation system (INS) using an output of the vehicle sensor 40.

The navigation HMI 52 includes a display device, a speaker, a touch panel, keys, and the like. Part or all of the navigation HMI 52 may be shared with the HMI 30 described above. For example, instead of or in addition to inputting a destination of the host vehicle M via the HMI 30, the occupant may input the destination of the host vehicle M via the navigation HMI 52.

The route determination unit 53 determines a route (hereinafter referred to as a “map route”) from a position of the host vehicle M identified by the GNSS receiver 51 (or any input position) to the destination entered by the occupant using the HMI 30 or the navigation HMI 52, with reference to the first map information 54.

The first map information 54 is information in which a road geometry is represented by links indicating roads and nodes connected by the links. The first map information 54 may include, for example, road curvature or point of interest (POI) information. The map route is output to the MPU 60.

The navigation device 50 may provide route guidance using the navigation HMI 52 based on the map route. The navigation device 50, for example, may also be realized using functions of a terminal device such as a smartphone or tablet owned by the occupant. The navigation device 50 may transmit a current location and destination to a navigation server via the communication device 20 and acquire a route equivalent to the map route from the navigation server.

The MPU 60 includes, for example, a recommended-lane determination unit 61 and stores second map information 62 in a storage device such as an HDD or flash memory. The recommended-lane determination unit 61 divides the map route provided by the navigation device 50 into a plurality of blocks (for example, every 100 meters in a direction in which the vehicle travels) and determines a recommended lane for each block by referring to the second map information 62.

The recommended lane is a lane that is recommended to be traveled by the host vehicle M among one or more lanes formed on a road on which the host vehicle M exists. The recommended lane may be read as a target lane.

The recommended-lane determination unit 61 determines, for example, which lane number from the left the vehicle travels in. When there is a branch location on the map route, the recommended-lane determination unit 61 determines a recommended lane that allows the host vehicle M to travel on a reasonable route toward a branch destination.

The second map information 62 is higher accuracy map information than the first map information 54. The second map information 62 includes, for example, information on a center of a lane or a boundary of the lane. Further, the second map information 62 may include road information, traffic regulation information, address information (address/postal code), facility information, telephone number information, and the like. The second map information 62 may be updated as needed through communication of the communication device 20 with other devices.

The driving operator 80 includes, for example, an accelerator pedal, a brake pedal, a shift lever, a steering wheel, an irregular steering wheel, a joystick, and another operator. Sensors that detect an amount of operation or whether the operation has occurred are attached to the driving operator 80, and detection results thereof are output to the automated driving control device 100 or to some or all of the travel drive force output device 200, the brake device 210, and the steering device 220. The driving operator 80, particularly, the steering wheel alone or a combination of the steering wheel and the steering device 220 to be described later, is an example of a “steering apparatus.”

For example, a sensor attached to the steering wheel (hereinafter, a steering sensor) detects subtle electric current generated when the occupant touches the steering wheel (for example, a change in capacitance). The steering sensor may also detect steering torque generated around the steering wheel's rotational axis (shaft). When the steering sensor detects electric current or steering torque, the steering sensor outputs a signal indicating the detection result to the automated driving control device 100.

The direction indicator lever 85 (also referred to as a stalk or a switch), when operated by an occupant, turns on lamps attached to front and rear of the host vehicle M. Further, the direction indicator lever 85 is also operated to instruct a lane change of the host vehicle M. Operating the direction indicator lever 85 to instruct a lane change is also referred to as a one-touch function. Hereinafter, operating the direction indicator lever 85 to instruct a lane change will be referred to as a “lane change instruction operation.” The direction indicator lever 85 is another example of an “input interface.”

A lane change instruction may be made by inputting voice to a microphone included in the HMI 30 in addition to or instead of operating the direction indicator lever 85, or may be made by operating the touch panel included in the HMI 30 or another switch.

The in-vehicle camera 90 is a camera that images a cabin of the host vehicle M. The in-vehicle camera 90 is, for example, a digital camera that uses a solid-state imaging device such as a CCD or CMOS. When the in-vehicle camera 90 images the cabin of the host vehicle M, the in-vehicle camera 90 outputs image data to the automated driving control device 100.

The automated driving control device 100 includes, for example, a first control unit 120, a second control unit 160, a third control unit 170, and a storage unit 190.

Each of the first control unit 120, the second control unit 160, and the third control unit 170 is realized, for example, by a hardware processor such as a central processing unit (CPU) or a graphics processing unit (GPU) executing a program (software).

Some or all of these components may be realized by hardware (including circuitry), such as large scale integration (LSI), an application specific integrated circuit (ASIC), a field-programmable gate array (FPGA), or a system on chip (SOC), or may be realized by cooperation between software and hardware.

The program may be stored in advance in a storage device of the automated driving control device 100, such as a hard disk drive (HDD) or flash memory (a storage device including a non-transitory storage medium), or may be stored in a removable storage medium such as a digital versatile disc (DVD) or compact disc read-only memory (CD-ROM) and installed in the HDD or flash memory of the automated driving control device 100 by the storage medium (non-transitory storage medium) mounted in a drive device.

The storage unit 190 is realized by various storage devices described above. The storage unit 190 is realized, for example, by an HDD, flash memory, electrically erasable programmable read-only memory (EEPROM), read only memory (ROM), or random access memory (RAM). The storage unit 190 stores, for example, programs (instructions) that are read out and executed by a processor.

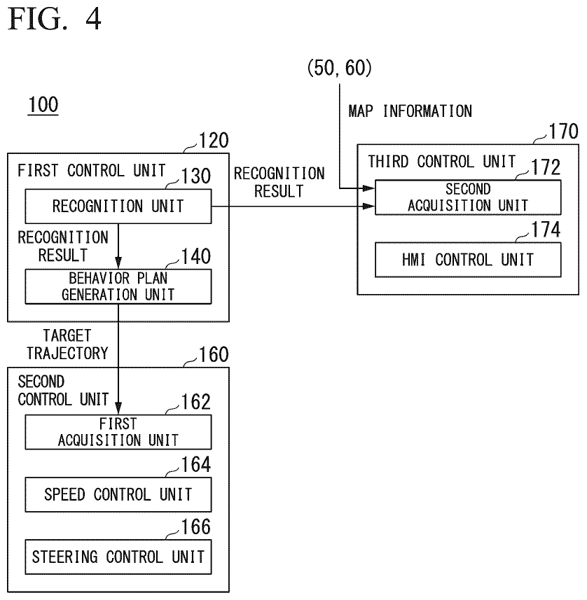

FIG. 4 is a functional configuration diagram of the first control unit 120, the second control unit 160, and the third control unit 170 according to an embodiment. The first control unit 120 includes, for example, a recognition unit 130 and a behavior plan generation unit 140.

The first control unit 120 realizes, for example, functions using artificial intelligence (AI) and functions based on a predetermined model in parallel. For example, a function of “recognizing an intersection” may be realized by performing, in parallel, recognition of the intersection using deep learning or the like and recognition based on predetermined conditions (there are, for example, signals and road markings that allow pattern matching), scoring both, and performing comprehensive evaluation. This ensures the reliability of automated driving.

The recognition unit 130 recognizes a surrounding situation or environment of the host vehicle M. For example, the recognition unit 130 recognizes objects present around the host vehicle M based on information input from the camera 10, the radar device 12, and the LIDAR 14 via the object recognition device 16.

The objects recognized by the recognition unit 130 include, for example, bicycles, motorcycles, four-wheeled vehicles, pedestrians, road signs, road markings, lane markings, utility poles, guardrails, and fallen objects.

Further, the recognition unit 130 recognizes states such as a position, speed, and acceleration of the object. The position of the object is recognized, for example, as a position on a relative coordinate system with a representative point of the host vehicle M (such as a center of gravity or a drive shaft center) as an origin (that is, a relative position with respect to the host vehicle M) and is used for control.

The position of the object may be represented by a representative point such as a center of gravity or corner of the object, or may be represented by a represented region. The “state” of the object may include acceleration, jerk, or “behavioral state” (for example, whether the object is changing lanes or is about to change lanes) of the object.

Further, the recognition unit 130 recognizes, for example, the lane in which the host vehicle M is traveling (hereinafter, a host lane) and another lane adjacent to the host lane (hereinafter referred to as an adjacent lane).

For example, the recognition unit 130 recognizes the host lane and adjacent lanes by comparing a pattern (for example, an arrangement of solid lines and broken lines) of a road lane marking obtained from the second map information 62 with a pattern of a road lane marking around the host vehicle M recognized from an image captured by the camera 10.

Further, the recognition unit 130 may recognize lanes such as the host lane or adjacent lanes by recognizing not only road lane markings but also a travel path boundary (road boundary) including road lane markings, shoulders, curbs, medians, guardrails, and the like. In this recognition, a position of the host vehicle M acquired from the navigation device 50 or processing results by the INS may be taken into account. The recognition unit 130 may also recognize stop lines, obstacles, red signals, tollgates, and other road events.

When the recognition unit 130 recognizes the host lane, the recognition unit 130 recognizes a relative position or posture of the host vehicle M with respect to the host lane. For example, the recognition unit 130 may recognize a deviation of a reference point of the host vehicle M from a center of the lane, and an angle formed with respect to a line connecting centers of the lane in a direction in which the host vehicle M travels, as a relative position and posture of the host vehicle M with respect to the host lane. Alternatively, the recognition unit 130 may recognize, for example, a position of the reference point of the host vehicle M with respect to either side edge of the host lane (the road lane marking or the road boundary) as the relative position of the host vehicle M with respect to the host lane.

When the host vehicle M is under automated driving on a route in which a recommended lane has been determined, the behavior plan generation unit 140 determines a driving mode of the automated driving. Hereinafter, information defining the driving mode of automated driving will be referred to as an event.

Events include, for example, a constant-speed driving event, a following driving event, a lane change event, a branching event, a merging event, and a takeover event. The constant-speed driving event is a driving mode in which the host vehicle M is caused to travel in the same lane at a constant speed. The following driving event is a driving mode in which the host vehicle M is caused to follow another vehicle (hereinafter referred to as a preceding vehicle) that is present within a predetermined distance (for example, within 100 meters) in front of the host vehicle M in the host lane and is closest to the host vehicle M.

“To follow” may refer to a driving mode in which an inter-vehicle distance (relative distance) between the host vehicle M and the preceding vehicle is maintained constant, or a driving mode in which the host vehicle M is caused to travel in a center of the host lane, in addition to the inter-vehicle distance between the host vehicle M and the preceding vehicle being maintained constant.

The lane change event is a driving mode in which the host vehicle M is caused to change lanes from the host lane to an adjacent lane. The branching event is a driving mode in which, at a branch point in a road, the host vehicle M is caused to branch into a lane on the destination side. The merging event is a driving mode in which, at a merging point, the host vehicle M is caused to merge into a main lane. The takeover event is a driving mode in which automated driving is terminated and switched to manual driving.

Further, events may include, for example, an overtaking event or an avoidance event. The overtaking event is a driving mode in which the host vehicle M is first caused to change lanes to an adjacent lane to overtake a preceding vehicle in the adjacent lane and then caused to change lanes back to the original lane. The avoidance event is a driving mode in which the host vehicle M is caused to perform at least one of braking and steering in order to avoid an obstacle present in front of the host vehicle M.

Further, the behavior plan generation unit 140 may also change an event already determined for a current section to another event or determine a new event for the current section according to the surrounding situation recognized by the recognition unit 130 during the travel of the host vehicle M.

Further, the behavior plan generation unit 140 may determine an event in accordance with an occupant's operation with respect to the direction indicator lever 85 (or a switch, button, or the like used in place thereof). For example, when the occupant operates the direction indicator lever 85 to signal a left turn, the behavior plan generation unit 140 determines a lane change event in which the host vehicle M is caused to change lanes to an adjacent lane on the left side as viewed from the host vehicle M. Further, for example, when the occupant operates the direction indicator lever 85 to signal a right turn, the behavior plan generation unit 140 determines a lane change event in which the host vehicle M is caused to change lanes to an adjacent lane on the right side as viewed from the host vehicle M.

The behavior plan generation unit 140 generates a future target trajectory for automatically (that is, without depending on the driver's operation) causing the host vehicle M to travel in the travel mode defined by the event, in principle, so that the host vehicle M travels on the recommended lane determined by the recommended-lane determination unit 61 and the host vehicle M responds to the surrounding situation while traveling on the recommended lane. The target trajectory includes, for example, a position element defining a future position of the host vehicle M and a speed element defining, for example, a future speed of the host vehicle M.

For example, the behavior plan generation unit 140 determines, as the position element of the target trajectory, a plurality of points (trajectory points) that the host vehicle M should sequentially reach. The trajectory point is a point that the host vehicle M should reach for each predetermined travel distance (for example, several [m]). The predetermined travel distance may be calculated, for example, based on a road-following distance when the vehicle travels along a route.

Further, the behavior plan generation unit 140 determines, as the speed element of the target trajectory, a target speed and a target acceleration for each predetermined sampling time (for example, on the order of zero point several seconds). Further, each trajectory point may be a position that the host vehicle M should reach at a sampling timing corresponding to each predetermined sampling time. In this case, the target speed and target acceleration are determined by the sampling time and an interval between the trajectory points. The behavior plan generation unit 140 outputs information indicating the generated target trajectory to the second control unit 160.

The second control unit 160 controls the travel drive force output device 200, the brake device 210, and the steering device 220 so that the host vehicle M passes through the target trajectory generated by the behavior plan generation unit 140 at a scheduled time.

The second control unit 160 includes, for example, a first acquisition unit 162, a speed control unit 164, and a steering control unit 166.

The first acquisition unit 162 acquires information on the target trajectory (trajectory points) from the behavior plan generation unit 140 and stores the information in the memory of the storage unit 190.

The speed control unit 164 controls one or both of the travel drive force output device 200 and the brake device 210 based on the speed elements (for example, target speed or target acceleration) included in the target trajectory stored in the memory.

The steering control unit 166 controls the steering device 220 in accordance with the position element (for example, a curvature representing a degree of bending of the target trajectory) included in the target trajectory stored in the memory.

The processing of the speed control unit 164 and the steering control unit 166 is realized, for example, by a combination of feedforward control and feedback control. As one example, the steering control unit 166 executes a combination of feedforward control according to a curvature of a road ahead of the host vehicle M and feedback control based on a deviation from the target trajectory.

The travel drive force output device 200 outputs travel drive force (torque) for travel of the vehicle to drive wheels. The travel drive force output device 200 includes, for example, a combination of an internal combustion engine, an electric motor, and a transmission, and a power electronic control unit (ECU) that controls these components. The power ECU controls the above configuration according to information input from the second control unit 160 or information input from the driving operator 80.

The brake device 210 includes, for example, a brake caliper, a cylinder for transmitting hydraulic pressure to the brake caliper, an electric motor for generating hydraulic pressure in the cylinder, and a brake ECU.

The brake ECU controls the electric motor according to the information input from the second control unit 160 or the information input from the driving operator 80, so that brake torque corresponding to a braking operation is output to each wheel.

The brake device 210 may include, as a backup, a mechanism that transmits hydraulic pressure generated by operating the brake pedal included in the driving operator 80 to the cylinder via a master cylinder.

The brake device 210 is not limited to the above configuration; and may also be an electronically controlled hydraulic brake device that controls an actuator according to the information input from the second control unit 160 to transmit the hydraulic pressure from the master cylinder to the cylinder.

The steering device 220 includes, for example, a steering ECU and an electric motor. The electric motor, for example, applies force to a rack-and-pinion mechanism to change directions of the steered wheels. The steering ECU drives the electric motor according to the information input from the second control unit 160 or the information input from the driving operator 80, thereby changing the directions of the steered wheels.

The third control unit 170 includes a second acquisition unit 172 and an HMI control unit 174.

The second acquisition unit 172, for example, may acquire a recognition result of the recognition unit 130, acquire a first map including a route to the destination from the navigation device 50, or acquire a second map including a recommended lane from the MPU 60. The second acquisition unit 172 provides acquired various types of information to the HMI control unit 174.

The HMI control unit 174 controls the HMI 30 based on the various types of information acquired by the second acquisition unit 172. The HMI control unit 174 is an example of an “output control unit.”

For example, the HMI control unit 174 causes an advanced driver-assistance systems (ADAS) view to be displayed on the screen of the first display 32A.

The ADAS view is an image for, as one advanced driver assistance, guiding a lane (that is, recommended lane) to which the host vehicle M should move with a lane change to reach a destination, and recommending, to the occupant, execution of the auto lane changing (ALC) to the recommended lane.

In an ADAS view, for example, among a plurality of lanes recognized by the recognition unit 130, at least the host lane and the adjacent lane may be displayed, and lane markings of each of the host lane and the adjacent lane may be displayed, and the host vehicle M whose relative position with respect to the host lane has been recognized may be displayed, and objects (for example, other vehicles) existing around the host vehicle M may be displayed.

In the ADAS view, in addition to such recognition results, the lane guidance recommendation may be further displayed.

The lane guidance recommendation is information for guiding the occupant to a position of the recommended lane (more specifically, a relative position of the recommended lane with respect to other lanes) in order to guide the vehicle to the recommended lane determined by the MPU 60. The lane guidance recommendation is example of “lane guidance information.”

The lane guidance recommendation includes weak lane guidance recommendation and strong lane guidance recommendation. The weak lane guidance recommendation and the strong lane guidance recommendation are typically recommendations for requesting or guiding the occupant to change the lane of the host vehicle M to the recommended lane by manual driving. The strong lane guidance recommendation, as its name suggests, is a recommendation for more strongly requesting the occupant to move the host vehicle M to the recommended lane, as compared with the weak lane guidance recommendation. The weak lane guidance recommendation is example of “first lane guidance information,” and strong lane guidance recommendation is example of “second lane guidance information.”

For example, the HMI control unit 174 causes a lane change guide to be displayed on the screen of the first display 32A, as the weak lane guidance recommendation.

The lane change guide is a guide for guiding the position of the recommended lane to the occupant. For example, the lane change guide may be represented by a plurality of arrows arranged in a direction in which the lane extends.

For example, as the strong lane guidance recommendation, the HMI control unit 174 further highlights the periphery of the recommended lane with a predetermined effect (for example, wave-like effect) while causing the lane change guide to be displayed on the screen of the first display 32A.

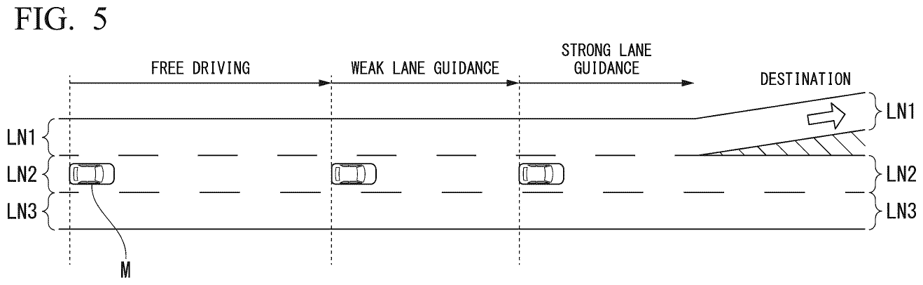

FIG. 5 is a diagram illustrating an example of a situation in which the host vehicle M is traveling. In the illustrated example, the host vehicle M is approaching the branching point that is one of guidance points. At the branching point, the lane LN1 branches from main lanes LN2 to LN3. That is, the lane LN1 is a branching lane. A destination of the host vehicle M exists ahead of the branching lane LN1, and the host vehicle M needs to change lanes to the branching lane LN1 at the branching point.

When a sufficient distance to the branching point is secured and a lane in which the host vehicle M should travel is not restricted, the occupant can cause the host vehicle M to travel while freely selecting the lane.

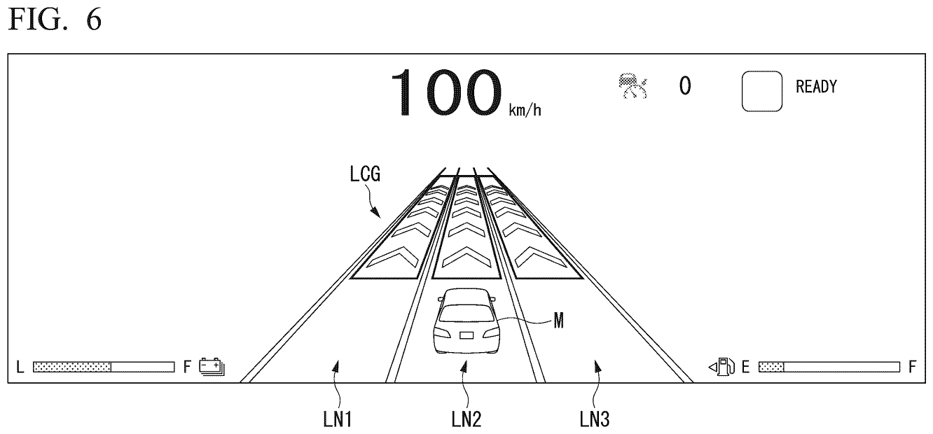

FIG. 6 is a diagram illustrating an example of the screen of the first display 32A under free traveling. LCG in the drawing represents the lane change guide.

Under free traveling, the host vehicle M can be caused to travel in any of the lanes LN1 to LN3. That is, all of the lanes LN1 to LN3 become the same recommended lanes. Therefore, the HMI control unit 174 causes the host vehicle M, the lanes LN1 to LN3, and the like to be displayed on the screen of the first display 32A, and further causes the lane change guide LCG to be displayed in each of the lanes LN1 to LN3, as illustrated in FIG. 6.

When the host vehicle M approaches the branching point (for example, when the host vehicle M reaches a point located a predetermined distance (several kilometers) before the branching point), the branching lane LN1 is determined to be the recommended lane. In such a case, the weak lane guidance recommendation is output.

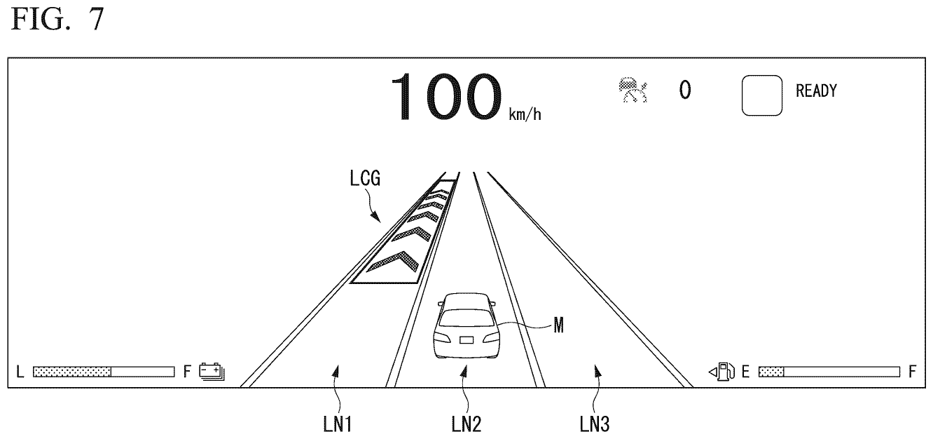

FIG. 7 is a diagram illustrating an example of the screen of the first display 32A under the weak lane guidance recommendation. For example, the HMI control unit 174 causes the host vehicle M, the lanes LN1 to LN3, and the like to be displayed on the screen of the first display 32A, and further causes the lane change guide LCG to be displayed on the lane LN1 that is the recommended lane, as the weak lane guidance recommendation, as illustrated in FIG. 7. Thus, it is possible to guide (request) the occupant to change the lane of the host vehicle M from the lane LN2 to the lane LN1 through manual driving.

When the host vehicle M does not move to the lane LN1 even after the weak lane guidance recommendation is output, the strong lane guidance recommendation is further output.

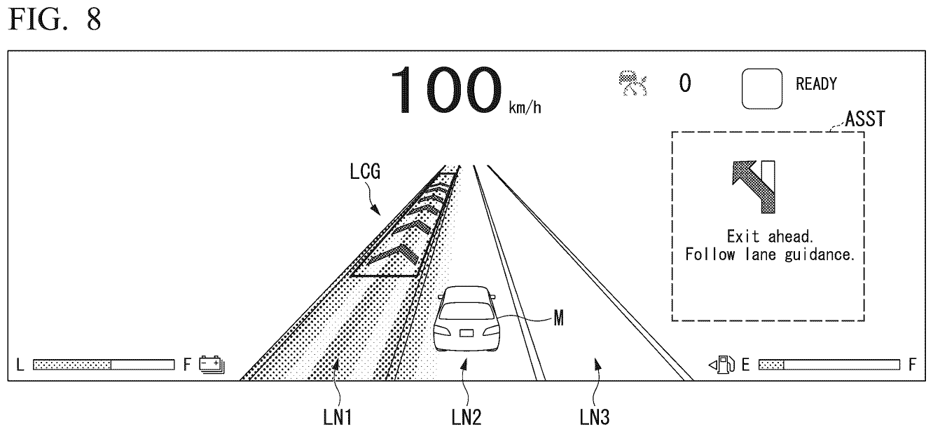

FIG. 8 is a diagram illustrating an example of the screen of the first display 32A under the strong lane guidance recommendation. For example, the HMI control unit 174 may cause the periphery of the lane LN1 to be highlighted with a predetermined effect (for example, wave-like effect) using an animation on the screen of the first display 32A while causing the lane change guide LCG to be displayed on the lane LN1, as the strong lane guidance recommendation, as illustrated in FIG. 8. Further, the HMI control unit 174 may cause a notification sound to be output from the speaker of the HMI 30. Thus, it is possible to guide (request) the occupant to change lanes to the lane LN1 through both vision and hearing.

In the ADAS view, the ALC recommendation may be further displayed, in addition to the above-described lane guidance recommendations (the weak lane guidance recommendation and the strong lane guidance recommendation).

The ALC recommendation is a recommendation of the ALC to the recommended lane for the occupant. That is, the ALC recommendation is information for recommending, to the occupant, that the automated driving control device 100 moves the vehicle M to the recommended lane through the auto lane changing, instead of the occupant himself/herself moving the host vehicle M to the recommended lane through the manual lane changing.

For example, as the ALC recommendation, the HMI control unit 174 may cause an indicator indicating that the ALC can be executed by the automated driving control device 100 (hereinafter referred to as an “ALC indicator”), an arrow indicating a relative direction of the recommended lane as viewed from the host vehicle M, and the like to be displayed on the screen of the first display 32A.

As illustrated in FIG. 8, the auxiliary information (ASST in the drawing) may be further displayed in addition to various recommendations described above.

The auxiliary information is other information that cannot be fully delivered to the occupant by an ADAS view alone. For example, the auxiliary information includes information for notifying the occupant that, when various events such as a branching event and a merging event are planned on an expressway or an automobile-only road, a guidance point (for example, a branching point or a merging point) at which a traveling path of the host vehicle M is to be changed in accordance with such event(s) is becoming closer, and/or for notifying occupant that a guidance for the recommended lane will start.

### Processing Flow

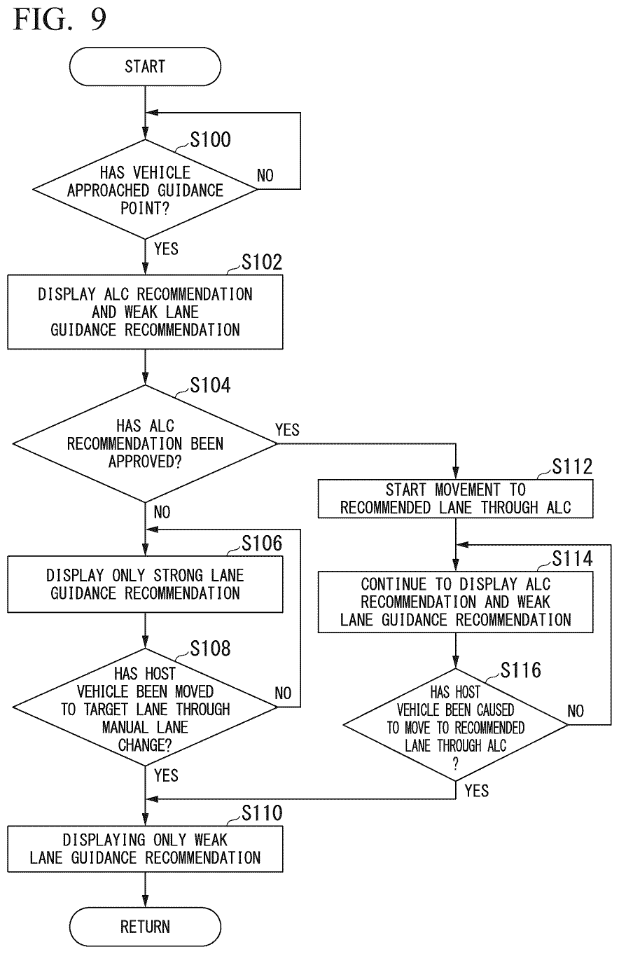

Hereinafter, a flow of a series of processes in the automated driving control device 100 of the embodiment will be described with reference to a flowchart. FIG. 9 is a flowchart illustrating an example of a flow of a series of processes in the automated driving control device 100 of the embodiment.

The processing of the present flowchart may be repeatedly executed, for example, at a predetermined cycle under the above-described free traveling.

First, the HMI control unit 174 waits until the host vehicle M approaches the guidance point (step S100).

As described above, the guidance point is a point at which a traveling path of the host vehicle M should be changed. More specifically, the guidance point is a point at which the host vehicle M or the occupant thereof is guided to change lanes to the recommended lane. Such a guidance point is, for example, a branching point or merging point. The guidance point may be read as the guide point.

For example, the HMI control unit 174 may determine that the host vehicle M has approached the guidance point when the host vehicle M has reached a predetermined point ahead of the guidance point as viewed from the host vehicle M. The predetermined point is a point for determining that the host vehicle M has approached the guidance point, and may be, for example, a point located predetermined distance (for example, 2 “km”) away from the guidance point.

When the host vehicle M has approached the guidance point, the HMI control unit 174 causes the ALC recommendation and the weak lane guidance recommendation to be simultaneously displayed on the same screen of the first display 32A (step S102).

Next, the HMI control unit 174 determines whether the ALC recommendation has been approved by the occupant (step S104).

For example, when the occupant has input, using the command switch 34 of the HMI 30, an operation for approving the ALC recommendation (hereinafter referred to as an “approval operation”), the HMI control unit 174 may determine that the ALC recommendation has been approved by the occupant.

Further, when the occupant has input the approval operation using the direction indicator lever 85, the HMI control unit 174 may also determine that the ALC recommendation has been approved by the occupant. For example, when the ALC for moving the host vehicle M to the adjacent lane on the left side of the host lane is recommended, when the occupant moves the direction indicator lever 85 and signals lane change to the left, the direction of the ALC and the signaling of the direction indicator lever 85 match, and therefore, it may be determined that the ALC recommendation has been approved by the occupant.

On the other hand, when the ALC recommendation is not approved (is disapproved), the ALC is not executed. In this case, the HMI control unit 174 causes only the strong lane guidance recommendation to be displayed on the screen of the first display 32A simultaneously with or after the disapproval of the ALC recommendation (step S106).

Here, there are two types of the ALC recommendations not being approved, that is, the ALC recommendation being disapproved.

A first disapproval is that the ALC recommended as the ALC recommendation is actively (or positively) canceled by the occupant and the ALC recommendation becomes disapproved.

For example, when the ALC for moving the host vehicle M to the adjacent lane on the left side of the host lane is recommended and when the occupant moves the direction indicator lever 85 and signals the lane change to the right, the direction of the ALC and the signaling of direction indicator lever 85 do not match. Thus, when an operation opposite to the approval operation is performed, it can be regarded that the occupant has actively canceled the ALC to the left recommended as the ALC recommendation. Hereinafter, canceling the ALC by operating the direction indicator lever 85 in this manner is referred to as a “cancel operation.”

The cancel operation may be performed, in addition to or in place of operating the direction indicator lever 85, by voice input to the microphone included in the HMI 30, or may be performed by operating the command switch 34 included in the HMI 30 or like.

Even when the ALC is canceled by the occupant's cancel operation, the HMI control unit 174 causes the strong lane guidance recommendation to be displayed on the screen of the first display 32A, as described above.

A second disapproval is that the ALC recommended as the ALC recommendation is passively (or negatively) canceled without an operation by the occupant and the ALC recommendation becomes disapproved.

For example, after the ALC recommendation is output, there may be a case in which there is neither approval operation nor cancel operation from the occupant. That is, there may be a case in which there is no response (reaction) from the occupant to the output of the ALC recommendation. In such a case, when the host vehicle M continues to travel, the host vehicle M may reach a give-up point.

The give-up point is a point determined in advance to be a point at which execution of the ALC is canceled (given up) by the automated driving control device 100 and is set, for example, ahead of the guidance point (for example, the branching point).

When the host vehicle M reaches the give-up point without the approval operation or cancel operation after the ALC recommendation is output, the ALC recommended as the ALC recommendation is passively canceled and the ALC recommendation becomes disapproved.

Further, even when there is the approval operation after the ALC recommendation is output, there may be a case in which the ALC is not started until the host vehicle M reaches the give-up point due to presence of another vehicle that becomes an obstacle to the ALC around the host vehicle M or presence of a construction site. In such a case, the ALC recommended as the ALC recommendation is passively canceled and the ALC recommendation becomes disapproved.

After strong lane guidance recommendation is displayed on the screen of the first display 32A, the HMI control unit 174 determines whether the occupant has moved the host vehicle M to the recommended lane through the manual lane changing in accordance with the strong lane guidance recommendation (step S108).

When the occupant has not moved the host vehicle M to the recommended lane through the manual lane changing, the HMI control unit 174 continues to cause the strong lane guidance recommendation to be displayed on the screen of the first display 32A.

On the other hand, when the occupant has moved the host vehicle M to the recommended lane through the manual lane changing, the HMI control unit 174 causes only the weak lane guidance recommendation to be displayed on the screen of the first display 32A (step S110).

On the other hand, in processing of S104, when the ALC recommendation has been approved by the occupant, the behavior plan generation unit 140 generates a target trajectory for automatically moving the host vehicle M to the recommended lane, and the second control unit 160 controls the travel drive force output device 200, the brake device 210, and the steering device 220 based on the target trajectory. Thus, the movement to the recommended lane by the ALC is started (step S112).

When the movement to the recommended lane by the ALC is started, the HMI control unit 174 continues to cause the ALC recommendation and the weak lane guidance recommendation to be displayed (step S114).

The HMI control unit 174 determines whether the movement to the recommended lane by the ALC has been completed (step S116).

When the movement to the recommended lane by the ALC has not been completed, the HMI control unit 174 continues to cause the ALC recommendation and the weak lane guidance recommendation to be displayed on the screen of the first display 32A. That is, during a period in which the ALC is continuing, the HMI control unit 174 continues to cause the ALC recommendation and the weak lane guidance recommendation to be displayed on the screen of the first display 32A.

On the other hand, when the movement to the recommended lane by the ALC has been completed, the HMI control unit 174 continues to cause only the weak lane guidance recommendation to be displayed on the screen of the first display 32A as processing of S110. Thus, the processing of present flowchart ends.

### Situation in Which ALC Recommendation is Not Approved

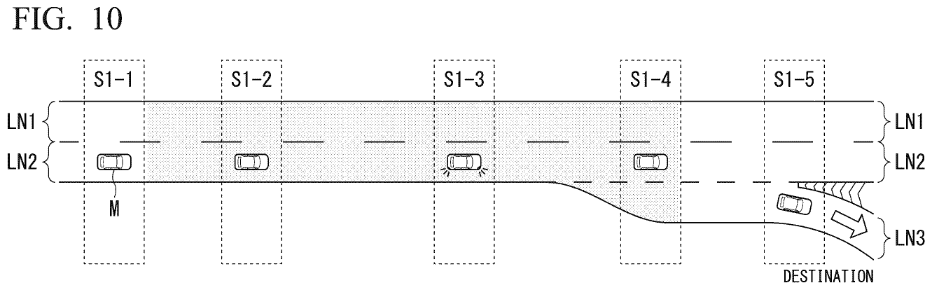

FIG. 10 is a diagram illustrating an example of a situation in which the ALC recommendation is not approved. As illustrated in FIG. 10, the situation can be classified into several scenes S1-1 to S1-5.

Scene S1-1 represents a scene in which free traveling is performed. Scene S1-2 represents a scene in which the host vehicle M has approached the branching point compared with scene S1-1, but a sufficient distance to the branching point is still secured. Scene S1-3 represents a scene in which the host vehicle M has further approached the branching point compared with scene S1-2, and a sufficient distance to the branching point is not secured.

Scene S1-4 represents a scene in which the host vehicle M has further approached the branching point compared with scene S1-3, and the host vehicle M has moved to immediately before the branching point without the ALC recommendation being approved by the occupant. Scene S1-5 represents a scene in which the host vehicle M is changing lanes to the recommended lane LN3 at the branching point.

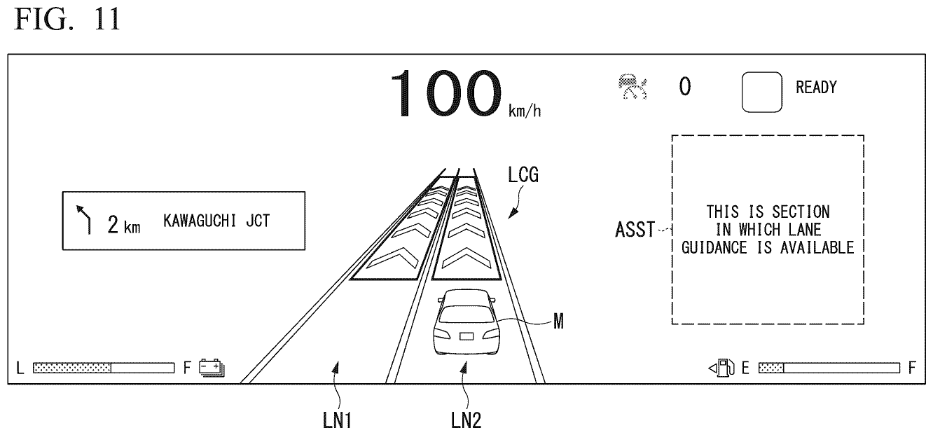

FIG. 11 is a diagram illustrating an example of the screen of the first display 32A in scene S1-1. Since free traveling is performed in scene S1-1, the lane change guides LCG is displayed on each of the lanes LN1 and LN2 in the ADAS view. Further, in order to notify the occupant that guidance for the recommended lane will be started, text such as “This is section in which lane guidance is available” is superimposed as the auxiliary information ASST on the ADAS view.

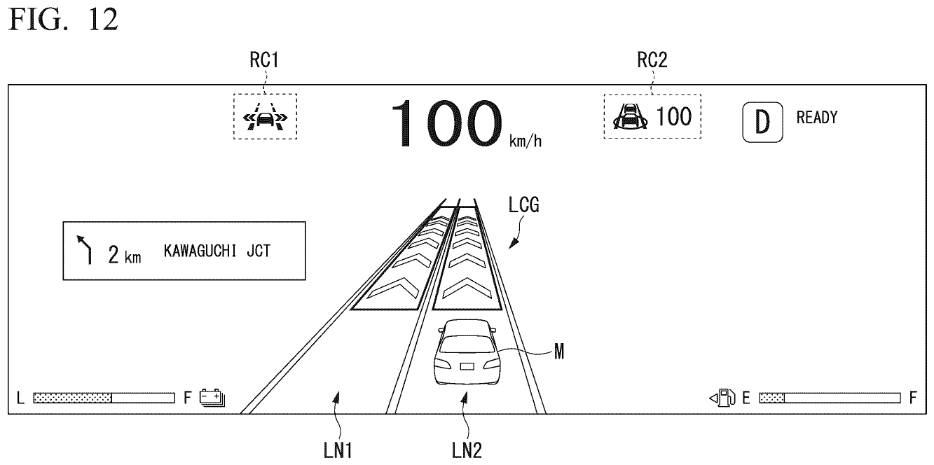

FIG. 12 is a diagram illustrating an example of the screen of the first display 32A in scene S1-2. In scene S1-2, the lane change guide LCG is displayed on each of the lanes LN1 and LN2 in the ADAS view, and further, the ALC indicator (RC1 and RC2 in the drawing) indicating that the ALC can be executed is displayed.

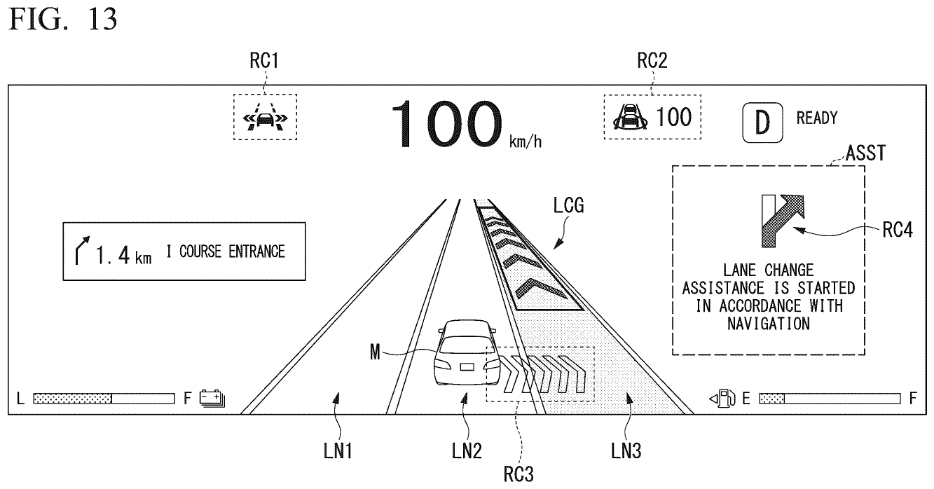

FIG. 13 is a diagram illustrating an example of the screen of the first display 32A in scene S1-3. In scene S1-3, the lane LN3 is newly displayed, in addition to the lanes LN1 and LN2, in the ADAS view. Since the lane LN3 is the recommended lane at the branching point, the lane change guide LCG is displayed on the lane LN3 as the weak lane guidance recommendation in the ADAS view.

Further, in scene S1-3, the ALC recommendation is displayed at the same timing as a display of the weak lane guidance recommendation in the ADAS view. Specifically, in addition to the ALC indicator such as RC1 or RC2, an arrow (RC3 in the drawing) indicating a relative direction of the lane LN3 is displayed as the ALC recommendation or an arrow (RC4 in the drawing) indicating a direction of branching within the auxiliary information ASST is displayed as the ALC recommendation.

Further, as the ALC recommendation, the lane LN3 on which the lane change guide LCG is displayed is drawn in a pattern or color different from color of the other lane LN1 or LN2 on which the lane change guide LCG is not displayed.

The HMI control unit 174 may cause a display aspect (color or pattern) of the lane LN3 on which the lane change guide LCG is displayed to be different in the ADAS view at a point in time when the ALC recommendation is approved, and thereafter, cause the ALC indicators (RC3 and RC4) to be displayed in the ADAS view at a point in time when it is determined that lane change is executable according to a situation in which the vicinity of the host vehicle M is recognized after the ALC recommendation is approved.

Further, the HMI control unit 174 may cause an object different from the arrow (RC4) indicating a direction of branching within auxiliary information ASST to be displayed as a recommendation for prompting the lane change.

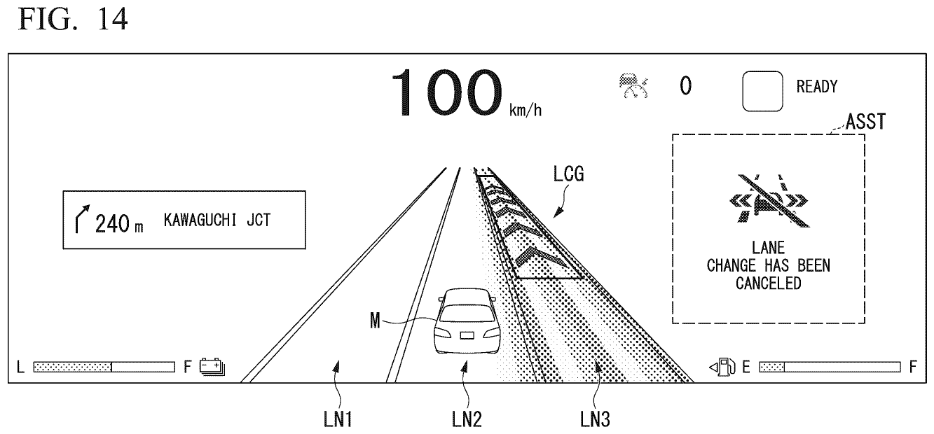

FIG. 14 is a diagram illustrating an example of the screen of the first display 32A in scene S1-4. In scene S1-4, the host vehicle M has moved to immediately before the branching point without the ALC recommendation being approved by the occupant. That is, the host vehicle M has reached the above-described give-up point without the approval operation or cancel operation by the occupant, and the ALC recommendation has been passively canceled and disapproved. In this case, the ALC is not executed. Therefore, the ALC recommendation is not displayed. Text indicating that the ALC has been canceled without being executed may be displayed as the auxiliary information ASST.

Further, in scene S1-4, it is necessary for the occupant himself/herself to perform the manual lane changing in order to move the host vehicle M to the lane LN3. Therefore, the strong lane guidance recommendation is displayed in the ADAS view instead of the weak lane guidance recommendation.

As illustrated in FIG. 14, as the strong lane guidance recommendation, the lane change guide LCG is displayed on the lane LN3 in the ADAS view, and further, the periphery of the lane LN3 is highlighted with a predetermined effect.

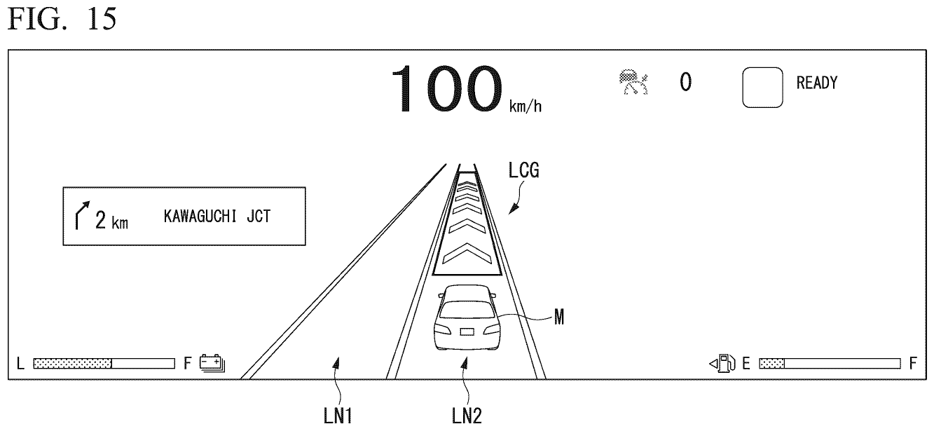

FIG. 15 is a diagram illustrating an example of the screen of the first display 32A in scene S1-5. In scene S1-5, the occupant himself/herself is moving the host vehicle M to the lane LN3 through the manual lane changing. In this case, the lane change guide LCG continues to be displayed on the lane LN3 as the weak lane guidance recommendation in the ADAS view.

### Situation in Which ALC Recommendation Is Approved

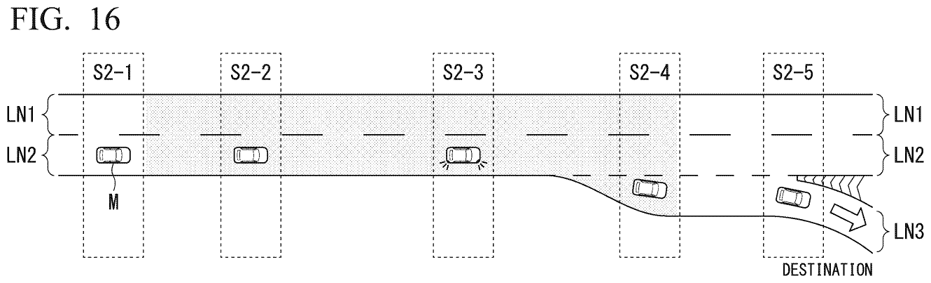

FIG. 16 is a diagram illustrating an example of a situation in which the ALC recommendation is approved. As illustrated in FIG. 16, the situation can be classified into several scenes S2-1 to S2-5.

Scene S2-1 represents a scene in which free traveling is performed, similarly to scene S1-1. Scene S2-2 represents a scene in which the host vehicle M has approached the branching point compared with scene S2-1, but a sufficient distance to the branching point is still secured. Scene S2-3 represents a scene in which the host vehicle M has further approached the branching point compared with scene S2-2, and a sufficient distance to the branching point is not secured.

Scene S2-4 represents a scene in which the host vehicle M has further approached the branching point compared with scene S2-3, and the ALC is executed in response to the ALC recommendation being approved by the occupant. Scene S2-5 represents a scene in which the host vehicle M is changing lanes to the recommended lane LN3 at the branching point.

The screen of the first display 32A in scene S2-1 is the same as the screen of the first display 32A in scene S1-1. Scenes S2-2, S2-3, and S2-5 are also the same as scenes S1-2, S1-3, and S1-5, respectively. Therefore, only scene S2-4, which is a different portion, will be described herein.

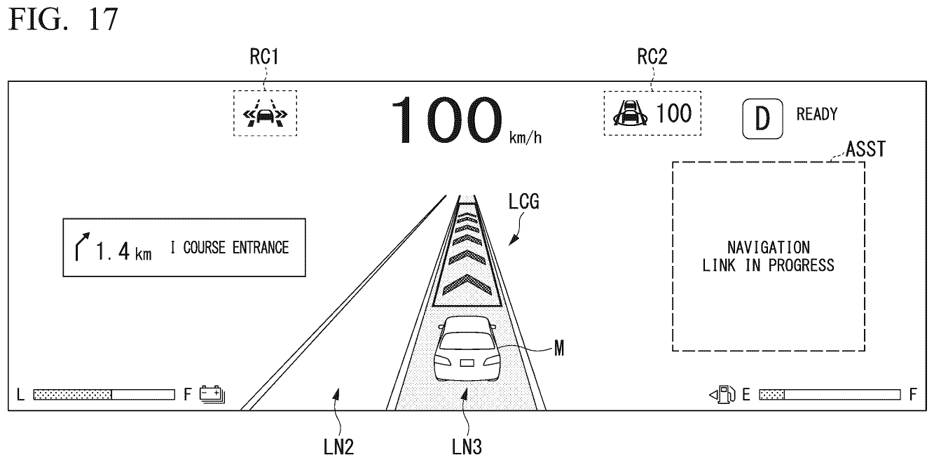

FIG. 17 is a diagram illustrating an example of the screen of the first display 32A in scene S2-4. In scene S2-4, the ALC is executed in response to the ALC recommendation being approved by the occupant, and the host vehicle M is moving to the lane LN3.

Therefore, in the ADAS view, the ALC recommendation and the weak lane guidance recommendation continue to be displayed. Specifically, as illustrated in FIG. 17, the lane change guide LCG is displayed as the weak lane guidance recommendation on the lane LN3. Further, as the ALC recommendation, the ALC indicator such as RC1 or RC2 is displayed, and/or the lane LN3 on which the lane change guide LCG is displayed is drawn in a pattern or color different from color of the other lane LN1 or LN2 on which the lane change guide LCG is not displayed.

According to the embodiment described above, the automated driving control device 100 causes the lane guidance recommendation (an example of “lane guidance information”) and the ALC recommendation (an example of “the auto lane changing recommendation information”) to be displayed on the same screen of the first display 32A, and causes the lane guidance recommendation to be displayed on the screen of the first display 32A simultaneously with the ALC recommendation being disapproved when the ALC recommendation is disapproved (that is, when either one of the two types of disapproval described above is made). With such configuration, information related to driving assistance can be provided to the occupant in easier-to-understand manner. As result, convenience of occupant can be further improved.

### Other Embodiments

Hereinafter, other embodiments will be described. In the above-described embodiment, the ADAS view including the lane guidance recommendation or the ALC recommendation is displayed on the screen of the first display 32A, but the present disclosure is not limited thereto. The ADAS view may be displayed on the screen of the second display 32B instead of the first display 32A, or may be displayed on another display device (for example, a head-up display).

Further, in the above-described embodiment, a case in which the content of the ADAS view is changed when the ALC recommendation is approved by the occupant and when the ALC recommendation is disapproved by the occupant has been described. More specifically, a case in which the occupant inputs the approval operation for the ALC recommendation using the command switch 34 of the HMI 30 or inputs the approval operation using the direction indicator lever 85 has been described. In addition to these, the approval operation for the ALC recommendation may be input using the steering wheel.

For example, when the ALC for moving the host vehicle M to the adjacent lane on the left side of the host lane is recommended, when the occupant turns the steering wheel to the left and starts the manual lane changing, it is determined that the ALC recommendation has been approved by the occupant. The HMI control unit 174 may continue to display the weak lane guidance recommendation without displaying the strong lane guidance recommendation even when the host vehicle M approaches the branching point or like after the manual lane changing is started.

Further, the HMI control unit 174 may continue to cause the ALC recommendation and the weak lane guidance recommendation to be displayed on the screen of the first display 32A during a period in which the manual lane changing is continuing.

Further, in the above-described embodiment, a case in which, as in processing of S112, when the movement to the recommended lane by the ALC is started during the period in which the weak lane guidance recommendation is displayed, the HMI control unit 174 continues to display the weak lane guidance recommendation has been described, but the present disclosure is not limited thereto.

For example, when the movement of the host vehicle M to the recommended lane by the ALC is started during the period in which the weak lane guidance recommendation is displayed, the HMI control unit 174 may stop displaying the weak lane guidance recommendation.

The same applies to not only to the ALC but also to the manual lane changing. For example, when the occupant himself/herself starts moving the host vehicle M to the recommended lane through the manual lane changing during the period in which the weak lane guidance recommendation is displayed, the HMI control unit 174 may stop displaying the weak lane guidance recommendation.

Although the embodiments for carrying out the present invention have been described above using the embodiments, the present invention is not limited to such embodiments in any way, and various modifications and substitutions may be made without departing from the gist of the present invention.

What is claimed is:

1. A display device comprising:
an output interface including at least a display; and
an output control unit configured to, using the output interface, guide a vehicle to a recommended lane to which the vehicle is be moved with a lane change, and recommend, to the occupant of the vehicle, execution of auto lane changing to the recommended lane,
wherein the output control unit
causes lane guidance information that is information indicating guidance for the recommended lane and auto lane changing recommendation information that is information indicating recommendation of execution of the auto lane changing to the occupant, to be displayed on the same screen of the display, and
causes the lane guidance information to be displayed on the screen simultaneously with the recommendation of the auto lane changing being disapproved.

2. The display device according to claim 1,
wherein the lane guidance information includes first lane guidance information, and second lane guidance information for more strongly requesting movement to the recommended lane than the first lane guidance information, and
the output control unit
causes the first lane guidance information to be displayed on the screen before the recommendation of the auto lane changing is disapproved, and
causes the second lane guidance information to be displayed on the screen when the recommendation of the auto lane changing is disapproved or after the recommendation of the auto lane changing is disapproved.

3. The display device according to claim 2, wherein the output control unit causes the first lane guidance information to be displayed on the screen simultaneously with the recommendation of the auto lane changing being started.

4. The display device according to claim 2, further comprising:
an input interface operated by the occupant,
wherein the output control unit does not cause the second lane guidance information to be displayed on the screen even when the vehicle approaches a guidance point that is a point at which guidance to the recommended lane is performed, when the auto lane changing is started in response to an approval operation being input to the input interface, the approval operation being an operation by the occupant for approving the recommendation of the auto lane changing.

5. The display device according to claim 4, wherein the output control unit continues to cause the first lane guidance information to be displayed on the screen during a period in which the auto lane changing is being executed.

6. The display device according to claim 2, further comprising:
a steering apparatus for adjusting a traveling path of the vehicle,
wherein the output control unit does not cause the second lane guidance information to be displayed on the screen even when the vehicle approaches a guidance point that is a point at which guidance to the recommended lane is performed, when the occupant has started manual lane changing using the steering apparatus during a period in which the auto lane changing is recommended.

7. The display device according to claim 6, wherein the output control unit continues to display the first lane guidance information on the screen during a period in which the manual lane changing is being executed.

8. The display device according to claim 2, further comprising:
a steering apparatus for adjusting a traveling path of the vehicle,
wherein the output control unit stops displaying the lane guidance information when the occupant has started manual lane changing using the steering apparatus to move the vehicle to the recommended lane during a period in which the first lane guidance information is displayed on the screen or when the auto lane changing has been started to move the vehicle to the recommended lane.

9. A display method using a computer mounted on a vehicle including an output interface including at least a display, the display method comprising:
using the output interface to guide a vehicle to a recommended lane to which the vehicle is to be moved with a lane change and to recommend execution of auto lane changing to the recommended lane to an occupant of the vehicle;
causing lane guidance information that is information indicating guidance for the recommended lane and auto lane changing recommendation information that is information indicating recommendation of execution of the auto lane changing to the occupant, to be displayed on the same screen of the display; and
causing the lane guidance information to be displayed on the screen simultaneously with the recommendation of the auto lane changing being disapproved.

10. A non-transitory computer-readable storage medium storing a program to be executed by a computer mounted on a vehicle including an output interface including at least a display, the program comprising:
using the output interface to guide a vehicle to a recommended lane to which the vehicle is to be moved with a lane change and to recommend execution of auto lane changing to the recommended lane to an occupant of the vehicle;
causing lane guidance information that is information indicating guidance for the recommended lane and auto lane changing recommendation information that is information indicating recommendation of execution of the auto lane changing to the occupant, to be displayed on the same screen of the display; and
causing lane guidance information to be displayed on the screen simultaneously with the recommendation of the auto lane changing being disapproved.
